(19) United States
(12) Patent Application Publication
(10) Pub. No.: US 2009/0022554 A1
(43) Pub. Date: Jan. 22, 2009

(54) Tool and Machine for Machining Operations Posing an Inverse Operation Risk

(75) Inventor: Alexandre Gourraud, Charenton Le Pont (FR)

Correspondence Address: YOUNG & THOMPSON, 209 Madison Street, Suite 500, ALEXANDRIA, VA, 22314, US

(73) Assignee: ESSILOR INTERNATIONAL (COMPAGNIE GENERALE D' OPTIQUE), Charenton Le Pont (FR)

(21) Appl. No.: 11/886,550

(22) PCT Filed: Mar. 10, 2006
(86) PCT No.: PCT/FR2006/000534

§ 371 Date: Sep. 17, 2007

(30) Foreign Application Priority Data
Mar. 17, 2005 (FR) 0502650

(51) Int. Cl. B26D 1/00; B23B 39/06

(52) U.S. Cl. 407/113; 408/13

(57) ABSTRACT

The invention relates to a tool (7B) comprising a cutting edge (24) that is located at the junction between a rake face and a flank face (23), said rake face having a front facet (26) that is intended to be moved transversely to the relative direction of movement (29, 30) between the piece (2) and the tool (7B) during machining operations and an inclined facet (27) that is disposed between the front facet (26) and the flank face (23). The above-mentioned cutting edge (24) is located at the junction between the inclined facet (27) of the rake face and the flank face (23).

The invention concerns the field of the fabrication of parts by machining.

It concerns more particularly a tool and a machine for machining operations posing a risk of inverse operation on a part.

This kind of risk of inverse machining is encountered, for example, when making use of a turning process to machine on a part driven in rotation about an axis a surface that, although it is transverse to said rotation axis, is prism-ballasted at the center relative to that rotation axis.

In fact, when an asymmetrical surface must be produced under these conditions, standard turning processes cannot be employed in that they allow only the machining of shapes that are symmetrical with respect to the rotation axis of the part. Processes are then used during which the part is driven in rotation while a machining tool is synchronized with the angular position of the part so as to follow the asymmetrical shape that it has to machine on the part.

The documents EP 1 449 616 and GB 2 058 619 describe such a process.

These processes enable machining of a surface that is prism-ballasted in the vicinity of the rotation axis of the part, i.e. the normal to said surface at the point of intersection with the rotation axis of the part forms an angle with the rotation axis. When the machining tool approaches the rotation axis of the part while it is working, a portion of the material to be removed necessitates that a portion of the tool continue its forward movement beyond the rotation axis of the part.

There is then noted the presence of a residual volume, called a “nipple”, which is removed by forcing the tool to operate intermittently in an inverse mode, i.e. with a direction of relative movement between the part and the tool that is opposite the working direction for which the tool was designed.

This is an improper use of the tool that can lead to its premature wear or even immediate damage in the form of flakes appearing at the cutting edge of the tool.

The object of the invention is to improve this type of tool for machining operations posing an inverse operation risk.

To this end, the invention is directed to a tool for machining operations posing an inverse operation risk on a part, this tool including a cutting edge situated at the junction between a rake face and a flank face, together with a rear face, characterized in that the rake face has a front facet adapted to be disposed substantially transversely to the direction of relative movement between the part and the tool during said machining operations and an inclined facet disposed between the front facet and the flank face, the cutting edge being situated at the junction between the inclined facet of the rake face and the flank face.

Such a tool has on its rake face an inclined facet that does not modify its behavior during operation of the tool in a nominal mode. The mode of operation of the tool is referred to as the nominal mode when it is effected in accordance with the use indicated by the manufacturer or the specifications of the tool, i.e. in the direction of relative movement between the tool and the part for which the tool was designed. The rake face of the tool then penetrates into the material while its flank face moves along the freshly machined material without causing additional rubbing.

On the other hand, during inverse operation of the tool, the flank face then plays the role of a rake face that penetrates into the material to form a chip while the inclined facet plays the role of a flank face.

This inclined facet also reinforces the cutting edge when it is loaded inversely by transferring a portion of the stresses on the edge onto the rake face, which produces a longer service life of the tool.

According to a preferred feature, the inclined facet has a height projected into the plane of the front facet of the order of 1 micrometer to 20 micrometers.

Also, the cutting edge can extend at least partially along a conical geometry contour and in particular along a circular arc contour in the plane normal to said direction of relative movement.

Moreover, the ratio between the height of the inclined facet projected into the plane of the front facet and the depth of pass for which the tool is designed is advantageously less than or equal to approximately 20%.

The cutting edge is advantageously disposed between the front facet and the rear face. The cutting edge is preferably closer to the front facet than to the rear face.

The tool can be made from polycrystalline diamond or monocrystalline diamond.

Another aspect of the invention is directed to a machining machine adapted to synchronize the position of a machining tool as described hereinabove with the angular position of a part driven in rotation about a rotation axis so as to machine on the part a surface that is asymmetrical with respect to the rotation axis.

This machine is advantageously adapted to machine the part with a depth of pass of the order of 0.01 millimeter to 10 millimeters.

Other features and advantages of the invention will become apparent in the light of the following description of a preferred embodiment given by way of nonlimiting example and with reference to the appended drawings, in which:

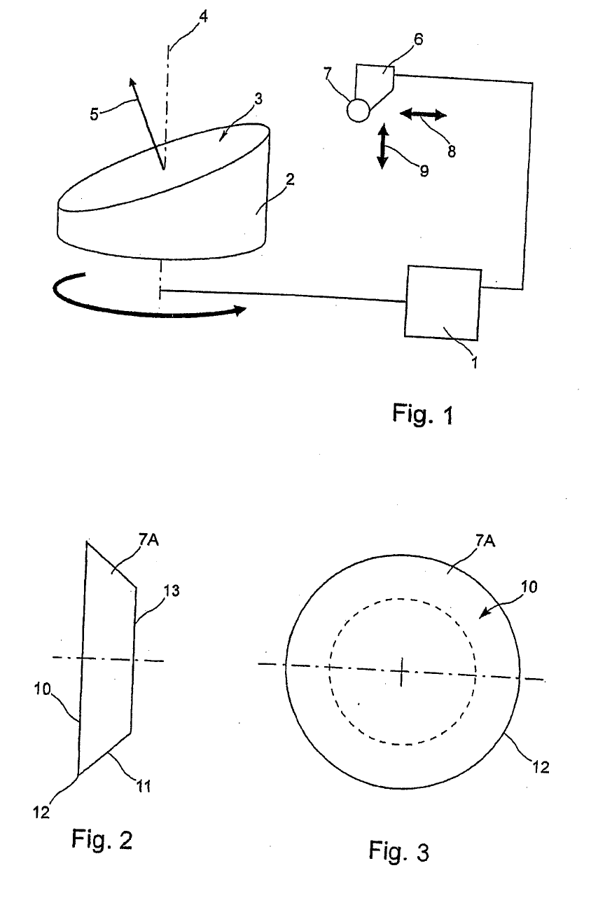

FIG. 1 is a perspective view representing diagrammatically a machining machine adapted to move a machining tool so that it cooperates in a turning operation with a part that has a prism-ballasted surface at the center and is driven in rotation;

FIGS. 2 and 3 represent a prior art machining tool, respectively in profile and from the front, that can be mounted on the machine from FIG. 1;

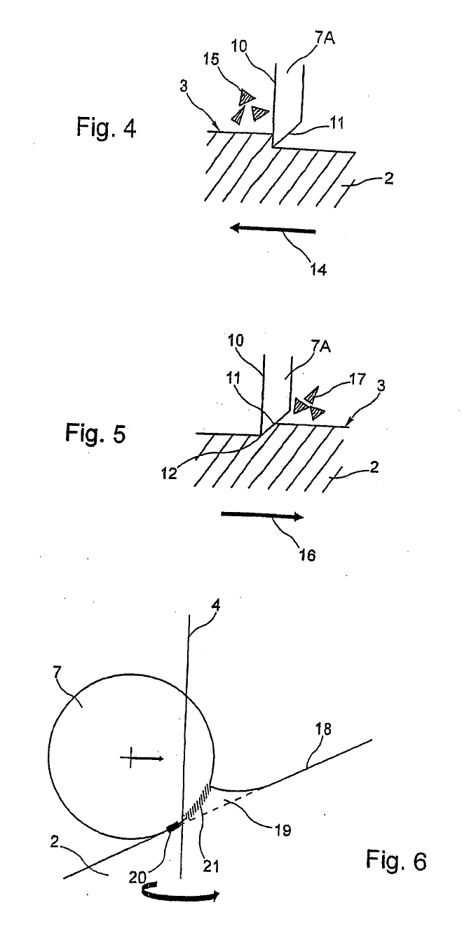

FIGS. 4 and 5 represent diagrammatically two modes of operation of the tool from FIGS. 2 and 3, respectively a nominal mode and an inverse mode;

FIG. 6 represents diagrammatically the tool from FIG. 1 when it is working partly in the inverse mode during the operation of the machine from FIG. 1;

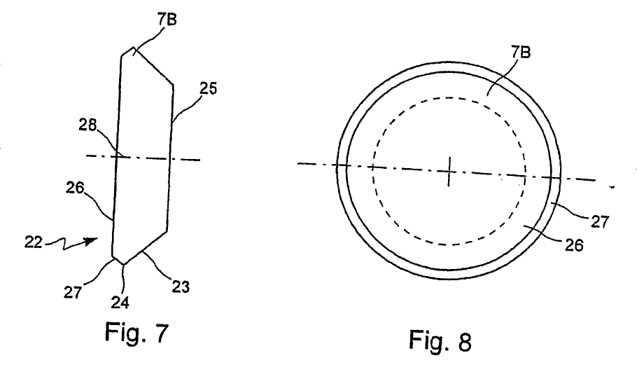

FIGS. 7 and 8 represent a machining tool according to the invention adapted to be mounted on the machine from FIG. 1, respectively in profile and from the front;

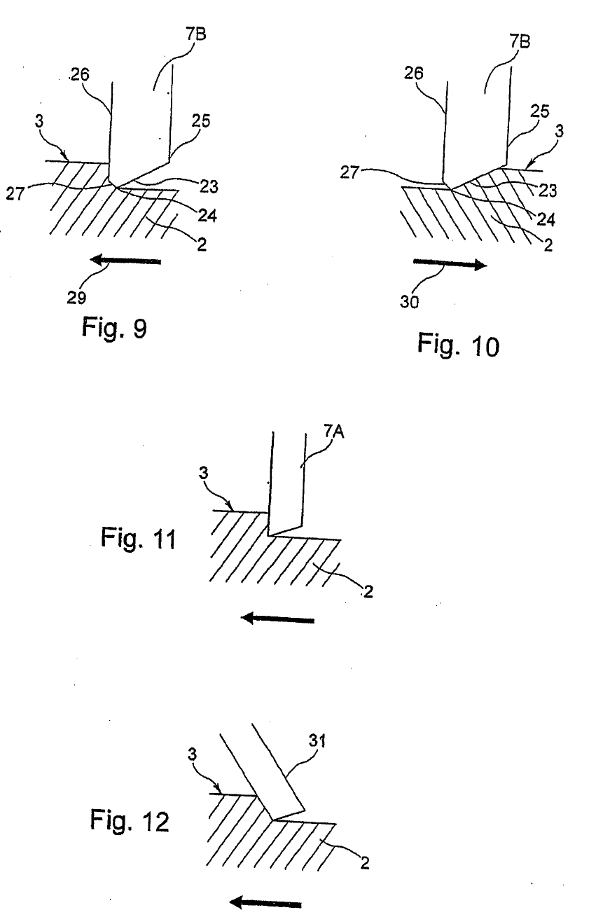

FIGS. 9 and 10 are diagrammatic views showing the tool from FIGS. 7 and 8 in profile when respectively working in the nominal mode and in the inverse mode;

FIGS. 11 and 12 represent, for comparison with FIGS. 9 and 10, two prior art tools working in the nominal mode.

The machining machine 1 represented diagrammatically in FIG. 1 is adapted to drive in rotation about an axis 4 a cylindrical part 2 that has a prism-ballasted face 3. The part 2 being prism-ballasted, the normal 5 to the face 3 at the point of intersection with the axis 4 is not parallel to that axis 4.

The machine 1 also drives movement in the directions 8 and 9 of a tool-carrier 6 to which a tool 7 is fixed.

The machine 1 is adapted to machine with the tool 7 a surface with a constant depth of pass over the prism-ballasted face 3. To this end, the machine 1 synchronizes the position of the tool 7 and the angular position of the part 2 in the direction 9 to follow the shape of the face 3 and to apply the required depth of pass to it, in addition to its forward movement in the direction 8.

FIGS. 2 and 3 represent a prior art tool 7A adapted to form the tool 7 from FIG. 1, respectively in profile and from the front (in FIG. 1, the tool 7 is seen from the front).

The tool 7A is of generally circular shape and has a rake face 10 and a flank face 11 both of which define a cutting edge 12, together with a rear face 13.

The tool 7A is fixed to the tool-carrier 6 from FIG. 1 by screwing it on or by any means enabling rigid linking of the tool 7A and the tool-carrier 6 so that the cutting edge 12 is accessible over at least a portion of the circumference of the tool 7 for machining the prism-ballasted face 3.

The prior art tool 7A is designed to operate in the nominal mode in the situation represented in FIG. 4.

The tool 7A penetrates into the material of the part 2 to a particular depth of pass, the tool 7A having a relative movement with respect to the part 2 indicated by the arrow 14.

The face 3 is therefore machined, the rake face 10 producing chips 15 by its forward movement into the material.

FIG. 5, on the other hand, represents the prior art tool 7A during inverse operation.

The relative movement of the tool 7A with respect to the part 2 being in the direction of the arrow 16, the tool 7A lifts chips 17 through the forward movement of its flank face 11 into the material.

This inverse operation of the tool 7A leads to premature wear of the cutting edge 12 and to the formation of flakes on the rake face 10, in the vicinity of the cutting edge 12.

FIG. 6 gives the example of a situation in which the tool 7 from FIG. 1 is constrained to operate in the inverse mode when machining the face 3 of the part 2. During this inverse operation, the tool 7 is employed in the manner shown diagrammatically in FIG. 5 for the tool 7A.

This FIG. 6 represents diagrammatically the tool 7 during machining of the part 2 driven in rotation about the axis 4 to machine a plane surface 18 to a constant depth of pass over the prism-ballasted face 3.

The tool 7 is in fact in the process of finishing the machining of the surface 18 by removing a nipple 19 of material. During the operation represented, the tool 7 straddles the rotation axis 4 which implies that in the region of the machining line 20 situated on one side of the axis 4 the tool 7 operates in the nominal mode whereas along the machining line 21 situated on the other side of the axis 4 the tool 7 operates in the inverse mode on the nipple 19 of material.

To improve the behavior of a tool 7 in the situation represented by way of example in FIG. 6, it is advantageous to employ a tool 7B according to the invention, represented in FIGS. 7 and 8.

That tool 7B has a circular general shape and includes a rake face 22 and a flank face 23, both defining at their junction a cutting edge 24, together with a rear face 25.

The rake face 22 itself includes a front facet 26 and an inclined facet 27.

The front facet 26 is substantially perpendicular to the axis 28 passing through the tool 7B (FIG. 7). The tool 7B being adapted to operate in a direction of movement parallel to this axis 28 in the present example, the front facet 26 is therefore adapted to penetrate into the material transversely to the direction of relative movement between the tool 7B and the part 2.

For its part, the inclined facet 27 forms an angle with the front facet 26 so that, when the tool 7B is operating in the nominal mode, the inclined facet 27 is in a position inclined toward the rear relative to the direction of movement of the tool 7B.

The inclined facet 27 being situated at the edge of the rake face 22, the cutting edge 24 is defined by the junction of that inclined facet 27 and the flank face 23. The cutting edge 24 is therefore to the rear relative to the cutting edge 12 of the prior art tool 7A represented in FIGS. 2 and 3.

FIGS. 9 and 10 represent diagrammatically the operation of the tool 7B on the part 2 when it is mounted on the machine from FIG. 1, respectively in the nominal direction and in the inverse direction.

In the nominal direction (FIG. 9), the tool 7B attacks the face 3 of the part 2 with its front facet 26 substantially transverse to the direction of relative movement 29 between the tool 7B and the part 2.

In this configuration, the height of the inclined facet 27 in the plane of the front facet 26 being small compared to the depth of pass, the behavior of the tool 7B in nominal operation is comparable to the behavior of the prior art tool 7A represented in FIG. 11.

Moreover, the behavior of the tool 7B in nominal operation is not comparable to the behavior of a tool 31 with a negative cutting angle (FIG. 12).

On the other hand, when the tool 7B is in inverse operation with a relative movement 30 (FIG. 10), the material of the part 2 is attacked by the flank face 23 of the tool 7B which is in the same disposition and which behaves like the front facet 26 in nominal operation. The flank face 23 then performs the machining while the inclined facet 27 reinforces the cutting edge 24 and plays the role of the flank face 23 in nominal operation of the tool 7B.

Variants of the device can be envisaged without departing from the scope of the invention. In particular, the tool 7B can have a general shape very different to that of the present example provided that it has a rake face having a front facet and an inclined facet.

1. Tool (7B) for machining operations posing an inverse operation risk on a part (2), this tool (7B) including a cutting edge (24) situated at the junction between a rake face (22) and a flank face (23), together with a rear face (25), characterized in that the rake face (22) has a front facet (26) adapted to be disposed substantially transversely to the direction (29, 30) of relative movement between the part (2) and the tool (7B) during said machining operations and an inclined facet (27) disposed between the front facet (26) and the flank face (23), the cutting edge (24) being situated at the junction between the inclined facet (27) of the rake face (22) and the flank face (23).

2. Tool according to claim 1, characterized in that the inclined facet (27) has a height projected into the plane of the front facet (26) of the order of 1 micrometer to 20 micrometers.

3. Tool according to claim 1, characterized in that the cutting edge (24) extends at least partially along a conical geometry contour.

4. Tool according to claim 1, characterized in that the cutting edge (24) extends along a circular arc contour in the plane normal to said direction (29, 30) of relative movement.

5. Tool according to claim 1, characterized in that the ratio between the height of the inclined facet (27) projected into the plane of the front facet (26) and the depth of pass for which the tool (7B) is designed is less than or equal to approximately 20%.

6. Tool according to claim 1, characterized in that the cutting edge (24) is disposed between the front facet (26) and the rear face (25).

7. Tool according to claim 6, characterized in that the cutting edge (24) is closer to the front facet (26) than to the rear face (25).

8. Tool according to claim 1, characterized in that the angle formed between the flank face (23) and said direction of movement is substantially equal to the angle formed between the inclined facet (27) and said direction of movement.

9. Tool according to claim 1, characterized in that it is made from polycrystalline diamond.

10. Tool according to claim 1, characterized in that it is made from monocrystalline diamond.

11. Machining machine adapted to synchronize the position of a machining tool (7B) according to claim 1 with the angular position of a part (2) driven in rotation about a rotation axis (4) so as to machine on the part (2) a surface that is asymmetrical with respect to the rotation axis (4).

12. Machine according to claim 11, characterized in that it is adapted to machine the part (2) with a depth of pass of the order of 0.01 millimeter to 10 millimeters.

13. Tool according to claim 2, characterized in that the cutting edge (24) extends at least partially along a conical geometry contour.

14. Tool according to claim 2, characterized in that the cutting edge (24) extends along a circular arc contour in the plane normal to said direction (29, 30) of relative movement.

15. Tool according to claim 3, characterized in that the cutting edge (24) extends along a circular arc contour in the plane normal to said direction (29, 30) of relative movement.

16. Tool according to claim 2, characterized in that the ratio between the height of the inclined facet (27) projected into the plane of the front facet (26) and the depth of pass for which the tool (7B) is designed is less than or equal to approximately 20%.

17. Tool according to claim 3, characterized in that the ratio between the height of the inclined facet (27) projected into the plane of the front facet (26) and the depth of pass for which the tool (7B) is designed is less than or equal to approximately 20%.

18. Tool according to claim 4, characterized in that the ratio between the height of the inclined facet (27) projected into the plane of the front facet (26) and the depth of pass for which the tool (7B) is designed is less than or equal to approximately 20%.

19. Tool according to claim 2, characterized in that the cutting edge (24) is disposed between the front facet (26) and the rear face (25).

20. Tool according to claim 3, characterized in that the cutting edge (24) is disposed between the front facet (26) and the rear face (25).
